(19) United States
(12) Patent Application Publication
(10) Pub. No.: US 2024/0029223 A1
(43) Pub. Date: Jan. 25, 2024

(54) INSECT IDENTIFICATION SYSTEM AND METHOD

(71) Applicant: John Bernard HUNT, Southampton, NY (US)

(72) Inventor: John Bernard HUNT, Southampton, NY (US)

(21) Appl. No.: 18/223,225

(22) Filed: Jul. 18, 2023

Related U.S. Application Data
(60) Provisional application No. 63/390,422, filed on Jul. 19, 2022.

(51) Int. Cl. G06T 7/00; G06N 3/045

(52) U.S. Cl. CPC G06T 7/0002; G06N 3/045; G06T 2207/20081; G06T 2207/30

(57) ABSTRACT

A computer-implemented system for automatic identification and classification of an insect that has a device connected to a camera, a processor, and a non-transitory machine-readable medium having instructions stored therein, which when executed by the processor, cause the processors to perform the following operations: receiving a live-time image of the insect captured by the camera, determining from the live-time image an irrelevant image data and a relevant image data, determining identification and classification of the insect from the relevant image data by using a convolutional neural network (CNN) module, and providing an alert based on the identification and classification of the insect.

### BACKGROUND

The subject matter of this application is related to U.S. Provisional Application No. 63/390,422, filed on Jul. 19, 2022, which is hereby incorporated by reference in its entirety.

The present invention generally relates to an automatic identification and classification of insects or other organisms using computer vision. More specifically, the present invention relates to a computer-implemented system to automatically identify and classify an insect, for example, a tick, using convolutional neural network.

Ticks are the second largest vector of human diseases, after only mosquitoes. Ticks can transmit a plethora of diseases that evade diagnosis and treatment. Ticks are becoming more geographically widespread and populous as climatic patterns shift and the average yearlong global temperature warms. The incidence rate of tick-borne illnesses has risen dramatically over the past twenty years and is expected to rise by comparable rates by mid-century.

Tick borne illnesses are a major epidemiological concern. In the United States, ticks are responsible for 90% of all vector borne illnesses, and worldwide, they are the second largest vector, trailing behind mosquitoes. The most common tick-borne illnesses are Lyme Disease and other Borrelia bacterial infections, Rickettsial infections, Anaplasmosis, Babesiosis, Ehrlichiosis, and immune mediated phenomena.

Accordingly, there is a need for a system that can automatically detect and classify ticks before attachment to human hosts, or shortly thereafter, to mitigate their impact as a vector of disease.

### SUMMARY

In one aspect, the present invention provides a computer-implemented system for automatic identification and classification of an insect that has a device connected to a camera, a processor, and a non-transitory machine-readable medium having instructions stored therein, which when executed by the processor, cause the processors to perform the following operations: receiving a live-time image of the insect captured by the camera, determining from the live-time image an irrelevant image data and a relevant image data, determining identification and classification of the insect from the relevant image data by using a convolutional neural network (CNN) module, and providing an alert based on the identification and classification of the insect.

In another aspect, the present invention provides a computer-implemented automated method, the method having the steps of receiving a live-time image of the insect captured by a camera, determining from the live-time image an irrelevant image data and a relevant image data, determining identification and classification of the insect from the relevant image data by using a convolutional neural network (CNN) module, and providing an alert based on the identification and classification of the insect.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a computer-implemented system to automatically identify and classify an insect according to embodiments of the invention;

FIG. 2 depicts a diagram of a Convolutional Neural Network (CNN) module according to embodiments of the invention;

FIG. 3 depicts visual of training data of a CNN module according to embodiments of the invention; and

FIG. 4 depicts a diagram of a process to identify and classify an insect according to embodiments of the invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

Tick-borne diseases are no new phenomena. There are three major factors that are contributing to the mass proliferation of Lyme disease throughout the human population: climate change, deforestation, and dramatic biodiversity loss. Ticks are distributed across the globe, but only a handful are suited for human hosts—the CDC recognizes nine of such species of tick endemic to the US American Dog tick (Dermacentor Variabilis), Eastern Blacklegged tick (Ixodes Scapularis), Brown Dog tick (Rhipicephalus Sanguineus), Gulf Coast tick (Amblyomma maculatum), Lone Star Tick (Amblyomma Americanum), Rocky mountain tick (Dermancentor Andersoni), Western Blacklegged tick (Ixodes Pacificus), Asian Longhorned tick (Haemaphysalis longicornis), and Groundhog tick (Ixodes Cookei.)

Ticks are obligatory hematophagous ectoparasites that act as vectors of fungal, viral, bacterial, and protozoan diseases, while also capable of inducing immune mediated phenomena, such as Tick Toxicosis and Alpha-Galactosidase allergy. The CDC recognizes 16 domestic tick-borne illnesses as endemic to the United States: Anaplasmosis, Babeosis, Borellia Mayonii, Borrelia Miyamotoi, Bourbon Virus, Colorado Tick Fever, Ehrlichiosis, Heartland Virus, Lyme Disease, Powassan Disease, Rickettsia Rickettsiosis, Rocky Mountain Spotted Fever, STARI (southern Tick Associated Rash Illness), Tick Borne Relapsing fever, and Tularemia.

Currently, eight hundred sixty-nine tick species and subspecies are recorded. These are broken down into two major families: Ixodes, or hard-shell ticks, named for their sclerotized (hardened) scutum, and Argasidae, or soft bodied ticks, named for their lack of a scutum.

There are no biologically proven methods of disease mitigation or tick population control, diagnosis is often elusive, and treatment methods for tick-borne illnesses are not fully effective. The present invention provides a system that uses Computer Vision (CV) and a Convolutional Neural Network (CNN) to automatically identify and classify ticks before attachment to human hosts, or shortly thereafter, to mitigate their impact on a host.

Currently, technologies that could be used in the field of CV are many, among which the most commonly used two in the field of agriculture are image morphology based on OpenCV model vision library and SVM (support vector machine).

The SVM is based on the principle of deep learning technology, and can train image samples to achieve feature extraction so as to realize the aim of classification and identification. This method, however, has two shortcomings: (1) this method uses quadratic-programming to solve support vectors, so that if in the case of a great quantity of samples, the solving process of a matrix would occupy a great amount of running memory and operating time, thus being inefficient in operating performances; (2) classic SVM models only provide models of binary classification, but with respect to insect identification, the problem to be solved usually is multi-class classification; thus, the twenty five multi-classification problem can only be solved by combining the classic SVM models with other models, resulting in an increase of model complexity level and developing cost.

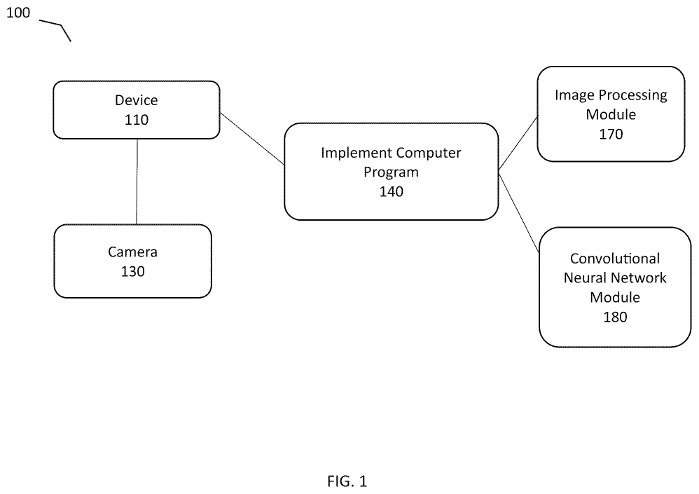

The present invention addresses the forgoing problems by using CV technology with a CNN module to efficiently identify a tick morphology and alert a user of a potential danger. The system of the present invention is described in more detail below and illustrated in FIGS. 1-4 and consists of a computer-implemented system for automatic identification and classification of an insect, for example, a tick, using CNN. In particular, a system 100 can have an image input, image processing, image data processing through the CNN module, classification and output.

As illustrated in FIG. 1, according to embodiments of the invention, each of the constituent parts of the system 100 may be implemented on any computer system suitable for its purpose and known in the art. Such a computer system can include a device 110, such as a personal computer, mobile device (e.g., a mobile phone or tablet), workstation, embedded system or any other computer system. Further, the device 110 can include a processor and memory for executing and storing instructions, a software with one or more applications and an operating system, and a hardware with a processor, memory and/or graphical user interface display. The device 110 may also have multiple processors and multiple shared or separate memory components.

According to embodiments of the invention, the system 100 includes a front-facing camera 130. The camera 130 can be embedded into the device 110. For example, a mobile device can be used as the device 110, such that the mobile device includes the camera 130. In this case, the camera 130 may be a webcam, a mobile phone camera, or a similar type of camera. However, it should be noted that a wide variety of devices 110 and camera 130 implementations exist, and the examples presented herein are intended to be illustrative only. The camera 130 can capture an image of an insect, for example, a tick.

According to embodiments of the present invention, the image can be a live-time feed from the camera 130, lit by a flash (not shown) of the device 110 to facilitate the construct of a topographical map of the image.

The device 110 has an implemented computer program 140 that operates one or more modules on the device 110 or remotely via cloud computing services accessible via network connection.

According to embodiments of the present invention, the implemented computer program 140 has an image processing module 170. The image processing module 170 is configured to process the image captured by the camera 130 to improve the image identification reliability by enhancing the relevant information and minimizing the irrelevant information. The image processing module 170 can be responsible for image denoising, white balance adjustment, image equalization and other operations to ensure image data normalization.

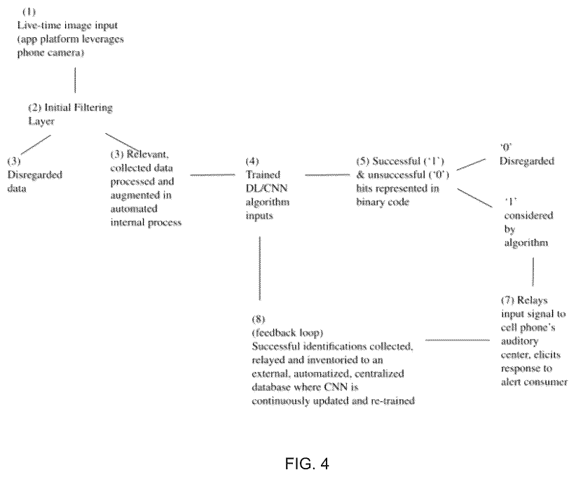

The image processing module 170 is also configured to process the live-time input image into two categories, an irrelevant image data and a relevant image data, as shown in FIG. 4.

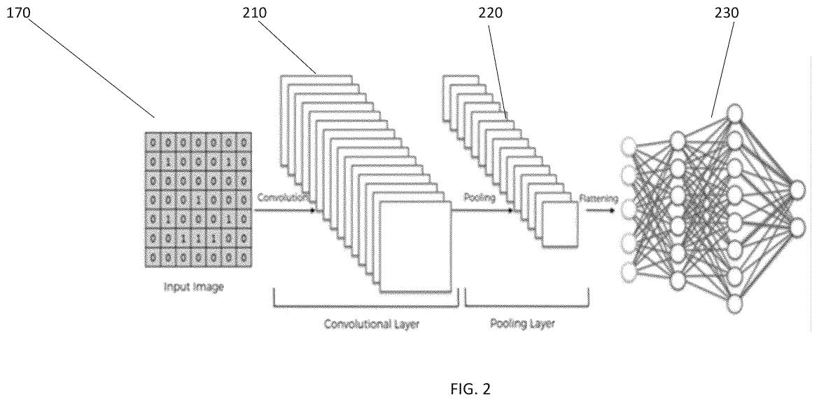

As further shown in FIGS. 1 and 2, the system 100 includes a CNN module 180. The relevant image data from the live-time input image derived from the image processing module 170 is processed through the CNN module 180.

According to embodiment of the present invention, as illustrated in FIG. 2, the CNN module 180 includes: a convolutional layer 210, a pooling layer 230, and a fully connected neural layer 230.

The convolutional layer 210 is where most of the calculations for the model are performed. A two-dimensional (2D) feature detector (e.g., 3×3 convolution matrix) is applied to the image, one region at a time. The summation of the portion of the matrix is entered into the corresponding region in an ‘output array.’ The kernel shifts over, corresponding to a ‘stride’ in the output array, until the array is full, with singular values representing regions of the initial image. This is referred to as a local connectivity or a partially connected region. According to embodiments of the present invention, the kernel filter remains of constant size as it moves across the image. Three settings: the number of filters, Stride distance, and zero padding are key components of the CNN. The number of filters refers to the number of epochs you desire for each image, or how many iterations of filtering each image should go through. This setting affects the depth of the output, that is, the more depth, the more accurate the model is. Stride is the number of pixels the filter moves per analysis, that is, a higher stride length results in less key points (numerical inputs) in the output array, while a lower stride length results in a more densely oriented output array. Zero padding is a function that is automatically applied when the kernel filter size and the image are not perfectly matched, portions that fall outside a designated region of the image are ignored and fall to zero. Padding ensures there are no discrepancies in the programming language between the inputs and outputs: valid padding drops the last convolution, or the least aligned convolution; same padding ensures that the input and output layers are of equal size, and full padding increases the size of the output by adding zeros to its border.

In the pooling layer 230, the convolutional layers are stacked atop one another for cross reference by the deep learning model for similar features. The pooling layer 230 is analogous to an added kernel-filter layer, i.e., a smaller matrix passes over the output arrays and creates ‘pooled’ output arrays and reduces the pixel size of the output array by half, down sampling the pixel to ¼ of its original size. Two operations, average pooling, which calculates an average value for the area it is considering and maximum pooling, which computes the most maximum value of the area under consideration, are most typically used. Pooling features creates a more generalized representation of the photo configuration and gives it a stronger invariance to changes in factors such as size, illumination, and orientation.

In the fully connected neural layer 250, each neuron connects to the neurons in the next layer. Because local groupings of neurons are responsible for the classification and recognition of specific areas and features of photos, different intensities of neural ‘firing’ actions cause different responses from the machine learning model. Local firing actions denote recognition of a specific region or feature within an input, whereas ‘worldwide’ firing denotes a broader connection between the input and the trained model. Again, thresholds can be set for the neuronal locality/universality required for the input image to be ‘recognized’ by the model.

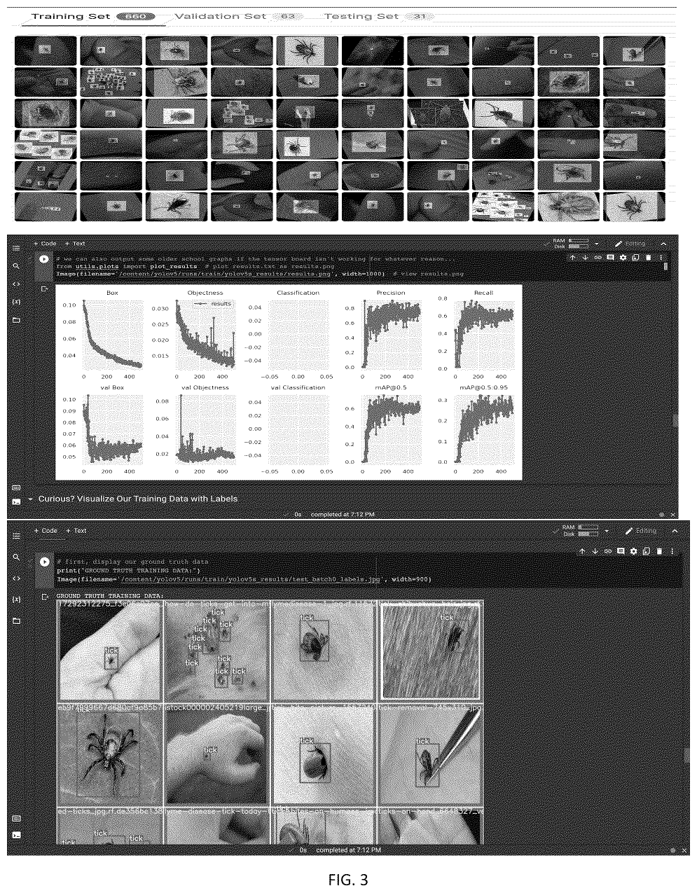

According to embodiment of the present invention, as illustrated in FIG. 3, the CNN of the CNN module 180 is trained by (i) application of the bounding box function, (ii) pooling and augmentation of annotations, (iii) application of annotations to the system 100, and (iv) cross-referencing against a ‘test’ dataset and ‘fully connecting’ to the CNN. Annotations of the images can be performed using Labellmg tool.

As the available images of insects are limited in quantity and additional images are difficult to be acquired, training of the deep convolutional neural training CNN with small data size of images of insects may lead to over-fitted model, which is unable to identify new images with poor generalization ability. According to embodiments of the present invention as shown in FIG. 4, the CNN is combined with Deep Learning (DL) techniques, for example, the transfer learning to process the insect images. The transfer learning facilitates the completion of learning tasks in a new environment by exploiting the knowledge acquired in previous environment. That is, in the deep learning training, the well-trained model parameters may be transferred to a new model to assist in training a new data set. Firstly, the CNN model is used for processing; secondly, the parameters of the well-trained CNN model are used to initialize the network parameters in the convolutional layers 210 and the fully connected layers 250; thirdly, a Gaussian distribution is used to randomly initialize the neuron parameters of the insects, and finally, the whole network is trained again using the data set of insects.

As shown in FIG. 1, the system 100 can have an insect classification module 190. The insect classification module 190 can classify and identify insects based on the image input of the insects, for example, ticks, by combining the CNN and the transfer learning model. Two detection methods can be used, one-stage detection (YOLO) and Two-stage detection (Faster-RCNN). YOLO is a simple object detection framework that skips object proposals and processes images directly into regression and classification boxes. YOLO can be deployable on iPhone devices with coreML capabilities.

FIG. 4 illustrates identification and classification of an insect, for example, a tick, according to embodiment of the present invention. The system 100 receives the live-time image input and filters the image into two categories, irrelevant image data and relevant image data, represented through binary code (0,1), respectively. The irrelevant image data is composed of separate convolutional neural networks that are specifically designed to recognize inputs, such as hair, warts, freckles, pimples, and other non-identifiable with insects inputs, that can be factors confusing with ticks in ‘single category’ data processing. The relevant image data is processed via a single convolutional neural network designed to recognize an insect, for example, a tick of the genus Ixodes: Ixodes Scapularis, Ixodes Ricinus, Ixodes Pacificus, Ambloymma Americana, and Dermacentor Variabilis. If the system 100 does not identify any regions of interest, i.e., regions identifiable with a specific genus of an insect, it will output a ‘0’, and the system 100 will reset and continue its normal function. If the system 100 identifies a region of interest, i.e., regions identifiable with a specific genus of an insect, system 100 will output a ‘1’, and the system will alert the user.

The alert can be in the form of an auditory or visual stimuli that the system 100 identified a region of interest or can provide a more detailed information in the form of a text or recording. The information can include first aid information, closest available medical help based on the geo-positioning of a user and other related information.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, mobile devices or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented system for automatic identification and classification of an insect, the system comprising:
a device connected to a camera;
a processor; and
a non-transitory machine-readable medium comprising instructions stored therein, which when executed by the processor, cause the processors to perform operations comprising:
receiving a live-time image of the insect captured by the camera;
determining from the live-time image an irrelevant image data and a relevant image data;
determining identification and classification of the insect from the relevant image data by using a convolutional neural network (CNN) module; and
providing an alert based on the identification and classification of the insect.

2. The system according to claim 1, wherein the irrelevant image data is represented by a binary code ‘0’.

3. The system according to claim 1, wherein the relevant image data is represented by a binary code ‘1’.

4. The system according to claim 1, wherein the CNN module comprises:
a convolutional layer;
a pooling layer; and
a fully connected neural layer.

5. The system according to claim 4, wherein the CNN module further comprises a transfer learning model.

6. The system according to claim 1, wherein the operations further comprise an image denoising, a white balance adjustment, and an image equalization.

7. The system according to claim 1, wherein the insect includes the group consisting of Ixodes Scapularis, Ixodes Ricinus, Ixodes Pacificus, or Ambloymma Americana.

8. The system according to claim 1, wherein the device is a mobile device.

9. A computer-implemented automated method to automatically identify and classify an insect, the method comprising:
receiving a live-time image of the insect captured by a camera;
determining from the live-time image an irrelevant image data and a relevant image data;
determining identification and classification of the insect from the relevant image data by using a convolutional neural network (CNN) module; and
providing an alert based on the identification and classification of the insect.

10. The method of claim 9, wherein the CNN module comprises:
a convolutional layer;
a pooling layer; and
a fully connected neural layer.

11. The method of claim 10, wherein the CNN module further comprises a transfer learning model.

12. The method of claim 9, wherein the irrelevant image data is represented by a binary code ‘0’.

13. The method of claim 9, wherein the relevant image data is represented by a binary code ‘1’.

14. The method of claim 9, wherein the insect includes the group consisting of Ixodes Scapularis, Ixodes Ricinus, Ixodes Pacificus, or Ambloymma Americana.

15. The method of claim 10, wherein the CNN module is trained by application of the bounding box function, (pooling and augmentation of annotations, (iii) application of annotations, and cross-referencing against a ‘test’ dataset and ‘fully connecting’ to the CNN module.
